(19) United States
(12) Patent Application Publication
(10) Pub. No.: US 2023/0079803 A1
(43) Pub. Date: Mar. 16, 2023

(54) Waste Treatment Package and Formulation for Treating Toilet Waste

(71) Applicant: Coversan, LLC, Savannah, MO (US)

(72) Inventor: Curtis Randall Hibbs, Savannah, MO (US)

(73) Assignee: Coversan, LLC, Savannah, MO (US)

(21) Appl. No.: 17/820,263

(22) Filed: Aug. 17, 2022

Related U.S. Application Data
(60) Provisional application No. 63/261,068, filed on Sep. 10, 2021.

(51) Int. Cl. B65D 81/32; B65D 65/46; C02F 1/68; C02F 1/72

(52) U.S. Cl. CPC B65D 81/3266; B65D 65/46; C02F 1/688; C02F 1/686; C02F 1/687; C02F 1/72; C02F 2103/005

(57) ABSTRACT

A waste treatment includes a package with compartments. A surfactant, an oxidizing agent, and, optionally, a liquid may be disposed within the compartments. The oxidizing agent is within a compartment that does not contain the surfactant or the liquid. A bursting force may unseal a sealed end of each compartment. The liquid flushes the surfactant and the oxidizing agent out of the package into a non-contact agitating toilet. A dual compartment package made with a fluidly disintegrable material may separate the surfactant from the oxidizing agent where the liquid may not be provided. The waste treatment may be mixed with a waste deposited within the non-contact agitating toilet. The package may disintegrate in the presence of the liquid to allow the reactive components to mix. A plurality of waste treatments may be connected. A perforated barrier may separate a first waste treatment from a second waste treatment.

### CROSS REFERENCES

This application claims priority of U.S. Provisional Application No. 63/261,068 filed 10 Sep. 2021.

### REFERENCE TO RESEARCH

Not Applicable.

### REFERENCE TO CDS

Not Applicable.

### FIELD OF THE INVENTION

The present disclosure relates to a waste treatment enclosed in a disintegrable, water-sensitive pouch having compartments enveloping powdered products separated by a dispersible barrier, where upon dispersion, the powdered products react in contact with an organic waste material.

### BACKGROUND

Human waste in toilet systems undergoes very minimal to no treatment prior to disposal in a septic system or sewage treatment plant. A conventional water-based toilet, typically connected to a pressurized water line, transfers waste from the water toilet to a wastewater line by water movement. A portable toilet closet, such as is commonly found at public outdoor events or construction sites, utilizes a fluid chemical blend to treat waste deposits to ensure user and public safety. A more personal use composting toilet, such as are used in residences without plumbing, requires the manufacturer of the toilet to instruct the owner how to install and operate their toilet system. An important instruction is to properly vent a composting toilet outside to minimize airborne particulate and odors inside the dwelling. The maker of the composting toilet may also instruct the owner of a recommended dry media that works best in their toilet for stabilizing the waste. These toilet systems generally require special handling techniques by trained installers to ensure the safe transport of waste to a sanitary location or decomposition of waste for the toilet's continued use.

The aforementioned waste material systems use media suffering from one or more of the following disadvantages. Water, as in the flush toilet example, depends upon the installer and the freshwater treatment facility to supply water for its function. This requires the use of relatively large amounts of water, which has been recognized as a valuable commodity, particularly in locations where water is a scarce resource. Chemicals, as used in portable toilet closets, use less water than their flush toilet counterparts but require the use of chemicals that may hinder the efficient decomposition of the waste. Disinfectant and/or deodorant chemical solutions also result in an accumulation of odorous and unpleasant sludge which must eventually be handled, dewatered, or stabilized to be transported and finally disposed. Composting, as used by many public parks for example, may use one or more types of microbes to decompose the waste in place. Yet the composting process provided by these microbes can often generate mold, fungus, bacteria and unpleasant odors that may require additional mechanisms, such as ventilation systems, thus limiting the locations where these composting toilets may be used. Dry absorptive media, such as dirt or sawdust, can become airborne and contaminate the user due to the buildup of static electric charges and kinetic energy. Use of dry media in a water toilet, if wetted, can foul plumbing or sewage treatment systems, limit toilet function or media effectiveness, and block waste transport.

### SUMMARY

A reactive waste treatment product includes a package, a quantity of surfactant, and a quantity of an oxidizing agent. The package has a first sealed end. A first compartment, that is sealed, is adjacent to the first sealed end. A first liquid component may be stored in the first compartment. A second compartment, that is sealed, is adjacent to the first compartment. A third compartment, that is sealed, may be adjacent to the second compartment. The quantity of surfactant is within one of the compartments separate from the liquid component. The surfactant is a foamable surfactant that is granular. The quantity of the oxidizing agent is within one of the compartments that does not contain the surfactant or the liquid component. The surfactant of the reactive waste treatment product may be between 40% to 97.75% of the total treatment formulation by volume. The oxidizing agent of the reactive waste treatment product may be between 2.25% to 20% of the total treatment formulation by volume.

A bursting force may be used on the package to unseal a sealed end of each compartment, thereby allowing the contents of the compartments to leave the package. Upon application of the bursting force to the package, the first compartment, the second compartment, and the third compartment unseal. The liquid component travels, preferably from the first compartment upstream of the second compartment and third compartment, through the compartments to a bottom end of the package. The liquid component flushes and washes out the surfactant and sodium percarbonate. The components may mix in package, upon flight from the package, and in the toilet.

In another example, the reactive waste treatment package may be fluidly disintegrable. The reactive waste treatment package keeps components separate prior to coming into contact with a liquid. The package may be made from one of, or a variety of, a dissolvable paper, polyvinyl alcohol film, non-calendared paper product, or other disintegrable material or substrate that loses structural integrity in the presence of a liquid. The package may be made of multiple materials. A triple compartment package or a dual compartment package might be used for the waste treatment products. If a liquid is enclosed in one of the compartments, the compartment holding the liquid may be made of waterproof material or have a waterproof sealant coating an interior side of that compartment.

In a dual compartment package, the first compartment contains the surfactant and the second compartment contains the sodium percarbonate. The compartments may be laterally adjacent or vertically aligned, viewed from the perspective of the package hung from a hanging slot.

Alternatively, in the case of a dual compartment package, the second compartment may be disposed within the first compartment. The waste treatment products are separated by a barrier that prevents mixing of the products before treatment. In the presence of a liquid, the package, including the compartments and barrier, disintegrate to allow the products to mix.

A plurality of reactive waste treatment product packages may be connected, where a first end of a first package is connected to a second end of a second package. A barrier, that is perforated, may exist between a first package of the reactive waste treatment product and a second package of the reactive waste treatment product.

The reactive waste treatment product can be used to treat waste, such as human toilet waste. A surfactant is inserted in a first compartment of a waste treatment package. Sodium percarbonate is inserted in a second compartment of the waste treatment package. The sodium percarbonate is contained isolated from the surfactant. The waste treatment package is deposited into a toilet, such as a non-contact agitating toilet. The waste treatment package within the toilet disintegrates in the presence of a fluid. The first dry component and the second dry component are mixed with a waste deposited within the toilet. The waste treatment package is comprised of a fluidly disintegrable material that may decay.

The above advantages and features are of representative embodiments only, and are presented only to assist in understanding the invention. It should be understood that they are not to be considered limitations on the invention as defined by the claims. Additional features and advantages of embodiments of the invention will become apparent in the following description, from the drawings, and from the claims.

### BRIEF DESCRIPTION OF DRAWINGS

Aspects are illustrated by way of example, and not by way of limitation, in the accompanying drawings.

FIG. 1 shows a front perspective view of a triple compartment package of one particular version of the reactive waste treatment product.

FIG. 2 shows a front perspective view of a plurality of dual compartment packages connected, where a first compartment is disposed within a second compartment of each dual compartment package.

FIG. 3 shows a front perspective view of a plurality of dual compartment packages connected, where a first compartment is adjacently connected to a second compartment of each dual compartment package.

FIG. 4 shows a flowchart for a method of waste treatment within a toilet.

### DETAILED DESCRIPTION

Organic waste material can be treated using a formulation as described in U.S. Publication No. US-2021-0131087-A1, published based on U.S. Non-provisional application Ser. No. 16/948,249 filed on 10 Sep. 2020 claiming priority to U.S. Provisional Application Ser. No. 62/928,161 filed on 30 Oct. 2019, for use in a toilet, specifically for use in a non-contact agitating toilet as described in U.S. Pat. No. 9,743,815, issued based on U.S. patent application Ser. No. 14/815,181 filed on 31 Jul. 2015, the specification and drawings of patent applications and patents listed in this paragraph are incorporated herein by reference.

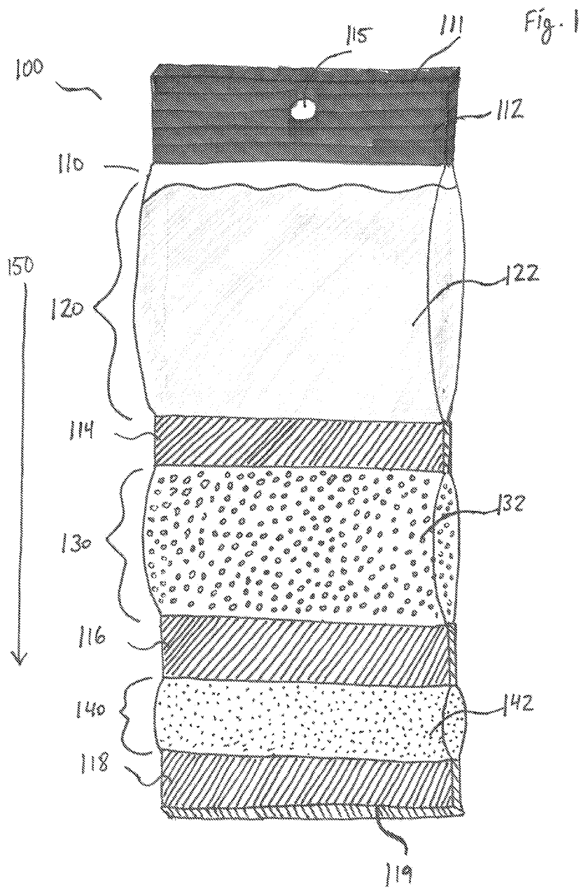

As shown in FIGS. 1, 2, and 3, the formulation can be delivered via a waste treatment package 110, 210, 310. The combination of the formulation and the waste treatment package 110, 210, 310 makes a waste treatment product 100, 200, 300 that may be deposited in a toilet, preferably a non-contact agitating toilet, for treatment of an organic waste. The waste treatment package 110, 210, 310 may be a sleeve, packet, pouch, pocket, bag, sack, or envelope of material selected from a variety of shapes and sizes. For example, the waste treatment package 110, 210, 310 may be semi-rounded, an elongated cylinder, rectangular, oval, or other rounded shape. It should be noted, the material of the waste treatment package 110, 210, 310 in FIGS. 1, 2, and 3 is shown in transparent form for the purpose of showing the inner contents, however the actual product package may be opaque or semi-transparent. The waste treatment package 110, 210, 310 comprises a first end 111, 211, 311 and a second end 119, 219, 319. An opening may be disposed at each of the opposite longitudinal ends of the waste treatment package 110, 210, 310 prior to addition of the formulation and formation of the waste treatment product 100, 200, 300 that is reactive.

As shown in FIGS. 1, 2, and 3, a plurality of seals or welds may secure (or join) the edges of the compartments. Seals (or barrier(s)) between the compartments may preserve and maintain separation of the formulation components that are reactive. Seals may be formed by means such as gluing with a bonding agent or adhesive, taping, tying, heat crimping, or other bonding means that secures the material together at binding portions or sealed areas of the waste treatment package 110, 210, 310. In the case where the material of the waste treatment package 110, 210, 310 is less disintegrable or dissolvable, the openings or ends of the package may be secured with a more disintegrable or dissolvable material that unseals in the presence of a liquid or agitation. Alternatively, the binding portion or sealed area may be treated to disintegrate in the presence of chemical, temperature, and/or mechanical stresses.

Now referring to FIG. 1, a particular version of a waste treatment package 110 is shown. The waste treatment package 110 has a first compartment 120 which may be formed adjacent to the first end 111. A first sealed zone 112 may be interposed between the first end 111 of the waste treatment package 110 and the first compartment 120. The first sealed zone 112 is a sealed area that is less burstable. At the opposite longitudinal end of the first compartment 120, a first burstable seal 114 may be disposed from a first side to a second side along a width of the waste treatment package 110. The first compartment 120 may contain a first liquid component 122 of the formulation.

A second compartment 130 may be formed adjacent to the first burstable seal 114. The second compartment 130 that is sealed may be disposed adjacent to the first compartment 120. At the opposite longitudinal end of the second compartment 130, a second burstable seal 116 may be disposed from the first side to the second side along a width of the waste treatment package 110. The second compartment 130 may contain a first dry component 132 of the formulation.

A third compartment 140 may be formed adjacent to the second burstable seal 116. The third compartment 140 that is sealed may be disposed adjacent to the second compartment 130. At the opposite longitudinal end of the third compartment 140, a third burstable seal 118 may be disposed from the first side to the second side along a width of the waste treatment package 110. The third burstable seal 118 may be formed adjacent to the second end 119. The third burstable seal 118 may be interposed between the second end 119 of the waste treatment package 110 and the third compartment 140. The third compartment 140 may contain a second dry component 142 of the formulation.

As shown in FIG. 1, the first liquid component 122 in the first compartment 120 is separated from the first dry component 132 in the second compartment 130. The first liquid component 122 of the formulation may correspond to a volume of the first compartment 120 and fill the volume of the first compartment 120 leaving little to no “dead” space. The first liquid component 122 may be pH adjusted to give a final liquid component pH of between 8.0 to 10.0. Alternatively, the first liquid component may have a pH between 3.0 to 6.0, or 3.0 to 11.0, or 6.0 to 8.0. For example, one or more bases may be added to the liquid component such as sodium hydroxide, potassium hydroxide, sodium carbonate, sodium bicarbonate, calcium hydroxide, or other commercially available bases. The first liquid component 122 may comprise a solvent that will dissolve and activate the first dry component 132 of the formulation. Examples of solvents are water, acetic acid, or other suitable polar solvent. Water, having the chemical formula of H₂O, is a polar solvent. Water is easily obtained and safely handled. For example, the first liquid component 122 can be obtained from a municipality or a naturally available supply source. The first liquid component 122 may comprise a liquid volume equal to the volume of the dry formulation. Alternatively, the first liquid component may comprise a liquid volume 1.2 times, 1.4 times, 1.5 times, 1.7 times, or 2 times (or a range thereof) greater than the volume of the dry formulation. Having a liquid component in excess of the dry components may generate a flowable treated waste product.

The first dry component 132 in the second compartment 130 is separated from the second dry component 142 in the third compartment 140. The first dry component 132 is isolated from the second dry component 142. The first dry component 132 in the second compartment 130 may correspond to a volume of the second compartment 130 and fill the volume of the second compartment 130 leaving little to no “dead” space. Alternatively, the first dry component 132 may be disposed within the third compartment 140 and the second dry component 142 disposed within the second compartment 130. The first dry component 132 may be a quantity of a foaming agent. The foaming agent may be a foamable surfactant that is granular. The surfactant may be a soap that is granular. Generally, soap is the product of saponification, which is the process of making the soap by the hydrolysis of glyceride esters of fatty acids to glycerol and sodium salts of the acids present. The surfactant of the formulation may be between 40% to 97.75% of the total treatment formulation by volume.

The second dry component 142 in the third compartment 140 is separated from the first dry component 132 in the second compartment 130. The second dry component 142 in the third compartment 140 may correspond to a volume of the third compartment 140 and fill the volume of the third compartment 140 leaving little to no “dead” space. Alternatively, the second dry component 142 may be disposed within the second compartment 130. The second dry component 142 may be a quantity of an oxidizing agent. The oxidizing agent may be a sodium percarbonate that is granular. Sodium percarbonate is an oxidizing agent commonly known as solid hydrogen peroxide having the chemical formula of 2Na₂CO₃.3H₂O₂. Sodium percarbonate is commercially available from a manufacturer or other supplier. The sodium percarbonate of the formulation may be between 2.25% to 20% of the total treatment formulation by volume. The sodium percarbonate may be left uncoated and physically isolated from the surfactant, a mostly dry ingredient, in a separate compartment. Having the dry components physically isolated in separate compartments may eliminate the an extra drying step or application of a sealant or coating to preserve the mostly dry components that are reactive. Another advantage to physically isolating the dry components may be a decrease in the decomposition of the dry components when contained in separate compartments.

The waste treatment package 110 may be made from material such as a polytube, thermoplastic packaging, polyethylene plastic, cellophane, coated polypropylene, or any flexible packaging material conducive to making a burstable zone or seal. The waste treatment package 110 may be made of dissolvable plastic such as polyvinyl alcohol, polyvinyl acetate, cellulose ethers, gum acacia, starch, dextrin, or any other appropriate water-soluble polymer film. The waste treatment package 110 may range in thickness from 0.5 millimeters (mm) to 3 mm or may comprise any appropriate thickness that is flexible and maintains durability when pressure is applied to unseal the burstable seals.

The waste treatment product 100 may be formed by forming machines. High-speed form-fill-seal machines may take a package film or sleeve of material and form multiple packages having seals or barriers between compartments. By way of example, vacuuming may be employed by a vertical form-fill-seal machine to form the compartments in a base layer of the package film. The second dry component 142 may be dispensed into the third compartment 140 first and closed with the third burstable seal 118. The first dry component 132 may be dispensed into the second compartment 130 second and closed with the second burstable seal 116. The first liquid component 122 may be dispensed into the first compartment 120 third and closed with the first burstable seal 114. The first sealed zone 112 may be formed and disposed above the first compartment 120. The first sealed zone 112 and the closed burstable seals defining the compartment ends may be formed by being pressed and heated with a heat sealer or heat bar of the common forming machine. Alternatively, an ultrasonic sealer, vacuum sealer, impulse sealer, or similar device may be used. A heat sealer may be used in forming the first sealed zone 112, the first burstable seal 114, the second burstable seal 116, and the third burstable seal 118 with a heat crimped seal. The heat crimped seal may be formed by a 3- to 12-inch direct heat sealer. The heat sealer may be equipped with a temperature dial to control the sealing temperature and an electronic timer to control the sealing time. When the correct settings have been established, seals may be formed repeatedly with the set heat, time, and pressure. The sealer may have hot sealing bars with different jaw designs such as meshed, serrated, or straight lined. The material of the waste treatment package is inserted in between the hot sealing bars then pressed together and released. The heat sealer may form a plurality of connected waste treatment packages with crimped heat seals. Alternatively, the perimeter seal may be trimmed within, or beyond, the seal or barrier to form an individual waste treatment packet.

The pressure for crimping a flexible polytube sleeve at a closed burstable seal may be between 50 and 150 Newtons of force (approximately 10 to 30 pounds of force). The heat crimped seal for a closed burstable seal may be formed by applying 90- to 100-degrees Celsius (C) (approximately 195 to 215 degrees Fahrenheit) of heat to the polytube for a time between 0.2 and 0.5 seconds. The pressure for crimping the flexible polytube sleeve at the first sealed zone 112 may be between 50 and 150 Newtons of force (approximately 10 to 30 pounds of force). The heat crimped seal for the first sealed zone 112 may be formed by applying 110- to 120-degrees C. (approximately 230 to 250 degrees Fahrenheit) of heat to the polytube for a time from 0.25 to greater than 0.5 seconds. The first sealed zone 112 may be formed by forming multiple heat crimped seals within a less-burstable zone.

As shown in FIG. 1, a hanging slot 115 may be disposed through the waste treatment package 110 within the first sealed zone 112 near the first end 111. The hanging slot 115 may allow the waste treatment package 110 to be hung on a peg or similar device at a precise location.

The first burstable seal 114, the second burstable seal 116, and the third burstable seal 118 are closed burstable seals configured to unseal. The closed burstable seals are disposed between the compartments of the waste treatment package 110. The closed burstable seals are more easily unsealed or burstable than the first sealed zone 112 that is less burstable. Pressure applied to the waste treatment package 110 pressurizes the compartments which may have little or no dead space. In so doing, immediate pressurization of the waste treatment package 110 occurs when pressure is applied. Building pressure causes the components of the formulation to seek the path of least resistance. The closed burstable seals unseal when pressure is applied to the waste treatment package 110. A directional bias forms within the waste treatment package 110 causing a preferential flow of the components from the first end 111 towards the second end 119. Alternatively, adequate pressure applied to the waste treatment package 110 may pressurize multiple compartments at once and break burstable seals simultaneously. Application of the bursting force to the waste treatment package 110, as shown in FIG. 1, causes the first liquid component 122, the first dry component 132, and the second dry component 142 to be expelled from the compartments in the direction of arrow 150. Such arrangement provides for the expulsion, or washing, of the dry components from the second compartment 130 and the third compartment 140 as the first liquid component 122 of the formulation travels through and leaves the waste treatment package 110.

The first liquid component 122, a fluid, may be arranged upstream of the first dry component 132. When applying pressure to the waste treatment package 110, the first burstable seal 114, the second burstable seal 116, and the third burstable seal 118 break whereby the first liquid component 122, the first dry component 132, and the second dry component 142 are expelled, such as into a non-contact agitating toilet. The pressure may be applied perpendicular to the direction of arrow 150. Pressure on the waste treatment package 110 may be applied by the hand of the user, by mechanical assist, a pinching mechanism, or any other device able to pressurize the waste treatment package 110. The first compartment 120, the second compartment 130, and the third compartment 140 are pressurized with the application of the pressure. The pressure may be transferred between compartments upon a component from an upstream compartment entering a downstream compartment. An upstream component entering a downstream compartment may flush out a downstream component out of the waste treatment package 110. Mixing of the components may occur in the waste treatment package and during the descending flight of the components to the floor of the toilet receptacle. Further mixing and agitation may occur within the toilet, such as when a non-contact agitating toilet is in use. Additionally, the user may drop the emptied waste treatment package into the toilet receptacle to aid in the comingling of waste treatment and waste by providing a slippery surface between the waste treatment formulation, waste treatment package 110, and the waste.

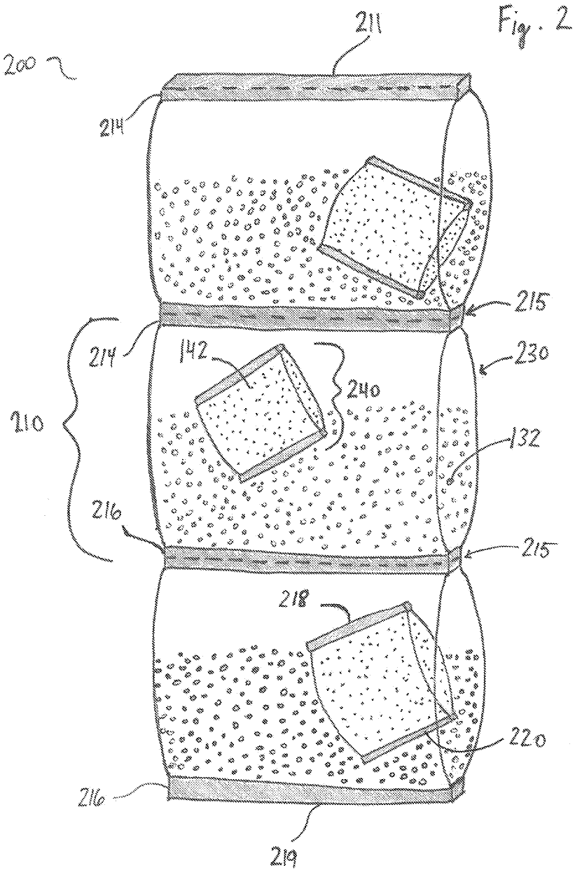

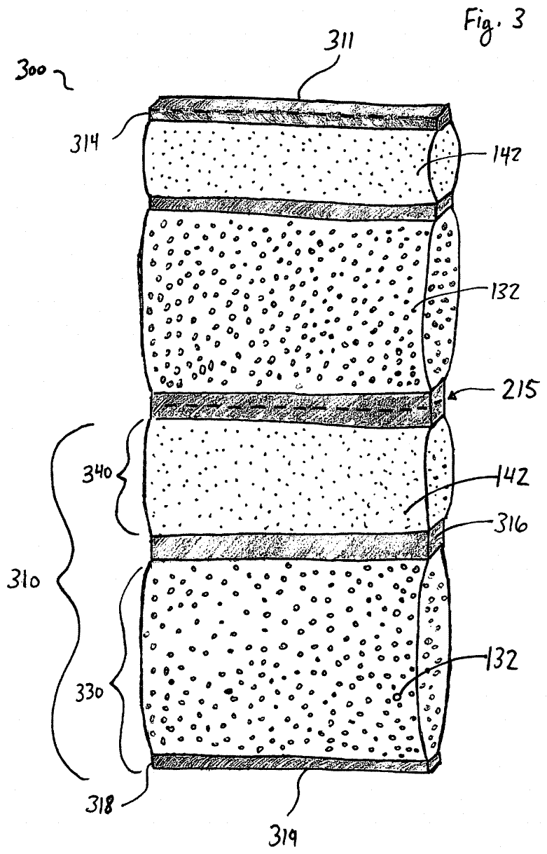

In FIG. 2 and FIG. 3, another version of the waste treatment product 200, 300 is shown. The waste treatment product 200, 300 comprises a waste treatment package 210, 310 that has dual compartments. The waste treatment package 210, 310 has a first end 211, 311 and a second end 219, 319. The waste treatment package 210, 310 has a first compartment 230, 330 that contains a first dry component 132 of the formulation and a second compartment 240, 340 that contains a second dry component 142 of the formulation. The dual compartments, connected adjacently together, keep the two dry components physically separated. In this example, the first liquid component 122 is not provided with the waste treatment product 100 that is reactive. The first liquid component 122 may be introduced by a user with the waste treatment product 200, 300 that is reactive. The first liquid component 122 may come from the user's urine, moist biological matter, or water obtained from facility plumbing, a separate bottle of water, nature, or other water source.

The waste treatment package 210, 310 may be made of a material that retains durability as a holding vessel while being fluidly disintegrable or dissolvable. The material of the waste treatment package 210, 310 may comprise any appropriate thickness. The thickness of the waste treatment package 210, 310 may be sized to maintain functionality of the package as a holding vessel and allow disintegration in the presence of a liquid such as water. The material of the waste treatment package 210, 310 may range in thickness from 0.5 millimeters (mm) to 3 mm. The material of the waste treatment package 210, 310 may be dissolvable plastic that is water-sensitive or water-soluble such as polyvinyl alcohol, polyvinyl acetate, cellulose ethers, gum acacia, starch, dextrin, or any other appropriate water-soluble polymer. Alternatively, the waste treatment package 210, 310 may be made of biodegradable material or septic safe material such as non-calendared paper, tissue paper, Kraft paper, cellophane. Alternatively, the package can be made of a material that is sensitive to chemical, temperature, or mechanical stresses imparted by the non-contact agitating toilet. The waste treatment package 210, 310 may be made with a combination of the referenced materials, such as paper material embedded with a polyvinyl alcohol. The waste treatment package 210, 310 formed from a paper material embedded with a dissolvable polyvinyl alcohol may not be treated with any water proofing substances. A material selected may increase a package's ability to rapidly dissolve or decay in the presence of a liquid or biological material, such as within approximately 10 seconds from initiation of interaction.

Now referring to FIG. 2, the waste treatment product 200 has a waste treatment package 210 with a first compartment 230 separate from a second compartment 240. In the example shown, a sleeve of material, as previously discussed, may be used for the waste treatment package 210. The first dry component 132 may be added to the first compartment 230 having a first sealed end 216 across the width of the waste treatment package 210. A second sealed end 214 is formed across the width of the waste treatment package 210 after the second dry component 142 is contained within the second compartment 240 and inserted into the first compartment 230. The second compartment 240 has a third sealed end 218 and a fourth sealed end 220. The second compartment 240 may be a separate, smaller package disposed within the first compartment 230 having a larger volume. The sealed ends of the first compartment 230 and the second compartment 240 may be disposed on opposite ends of each compartment. The waste treatment package 210 may then be cut off from the sleeve of material to form the waste treatment product 200 wherein the two dry components are physically separated within a single-use product.

Now referring to FIG. 3, the waste treatment product 300 has a waste treatment package 310 with a first compartment 330 and a second compartment 340. The first compartment 330 may be disposed and connected adjacent to the second compartment 340. In the example shown, a sleeve of material, as previously discussed, may be used for the waste treatment package 310. The first dry component 132 may be added to the first compartment 330 having a first sealed end 318 across the width of the waste treatment package 310. A barrier 316 is formed across the width of the waste treatment package above the first dry component 132. Then a second dry component 142 may be added to the second compartment 340. A second sealed end 314 is formed across the width of the waste treatment package 310. The waste treatment package 310 may then be cut off from the sleeve of material to form the waste treatment product 300 wherein the two dry components are physically separated by the barrier 316 within a single-use product.

A plurality of reactive waste treatment product packages may be connected, where a first end 111, 211, 311 of a first waste treatment package 110, 210, 310 is connected to a second end 119, 219, 319 of a second waste treatment package. A perforated seal 215 may exist between a first waste treatment package and a second waste treatment package. The perforated seal 215 may aid a user, who may purchase a plurality of waste treatment products in bulk, in depositing a single or multiple waste treatment products at a time during a toilet visit. In this way, the first waste treatment package may be detached from the second waste treatment package along the perforated seal 215 while maintaining the first sealed end 216, 318 or the second sealed end 214, 314 of the waste treatment package 210, 310, as shown in the example figures.

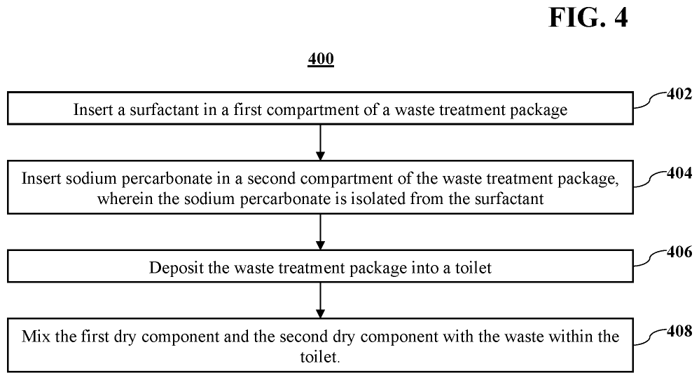

A method 400 for treating a waste material within a toilet is shown in the flowchart of FIG. 4. A first dry component, such as a surfactant, is inserted in a first compartment of a waste treatment package, according to step 402. A second dry component, such as sodium percarbonate, is inserted in a second compartment of the waste treatment package, according to step 404. The second dry component is isolated from the first dry component. A fluidly disintegrable material may be used in the construction of the waste treatment package. The waste treatment package is deposited into a toilet, according to step 406. The first dry component and the second dry component are mixed with the waste within the toilet, according to step 408. The waste treatment package disintegrates and may dissolve within the toilet in the presence of the moist waste or liquids.

In the case of a non-contact agitating toilet, a bag or bucket may be installed. Optionally, the interior surface of the bag or bucket may be wetted or moistened. A waste treatment product may be deposited within the toilet to prepare a waste treatment environment before or after a user deposits an organic waste material. The non-contact agitating toilet may be activated to agitate and tumble the waste treatment product. In the presence of a liquid, the waste treatment package of the waste treatment product may partially or fully disintegrate or dissolve within approximately 30 seconds. A compromised waste treatment package may allow dispersion and displacement of the dry components over a larger surface area. An advantage to this waste treatment product may be reduction of dusting or electrostatic forces that may contaminate the user. If no liquid is present, biological waste, such as urine or moist fecal matter, expelled into the toilet will disintegrate or dissolve the waste treatment package causing a reactive waste treatment as the dry components of the formulation interact with moisture present. Alternatively, the biological waste may be deposited first, followed by the activation of the toilet and deposition of a waste treatment product.

It is understood that the invention is not confined to the particular construction and arrangement of parts herein described. That although the drawings and specification set forth a preferred embodiment, and although specific terms are employed, they are used in a description sense only and embody all such forms as come within the scope of the following claims.

The present disclosure is not to be limited in terms of the particular embodiments described in this application, which are intended as illustrations of various aspects. Many modifications and variations can be made without departing from its spirit and scope. Functionally equivalent methods and apparatuses within the scope of the disclosure, in addition to those enumerated herein, are possible from the foregoing descriptions. Such modifications and variations are intended to fall within the scope of the appended claims.

For the convenience of the reader, the above description has focused on a representative sample of all possible embodiments, a sample that teaches the principles of the invention and conveys the best mode contemplated for carrying it out. Throughout this application and its associated file history, when the term “invention” is used, it refers to the entire collection of ideas and principles described; in contrast, the formal definition of the exclusive protected property right is set forth in the claims, which exclusively control. The description has not attempted to exhaustively enumerate all possible variations. Other undescribed variations or modifications may be possible. Where multiple alternative embodiments are described, in many cases it will be possible to combine elements of different embodiments, or to combine elements of the embodiments described here with other modifications or variations that are not expressly described. A list of items does not imply that any or all of the items are mutually exclusive, nor that any or all of the items are comprehensive of any category, unless expressly specified otherwise. In many cases, one feature or group of features may be used separately from the entire apparatus or methods described. Many of those undescribed variations, modifications and variations are within the literal scope of the following claims, and others are equivalent.

We claim:

1. A reactive waste treatment product comprising:
a. a package comprising:
i. a first compartment that is sealed, the first compartment comprising:
1. a quantity of a surfactant;
ii. a second compartment that is sealed and disposed adjacent to the first compartment, the second compartment comprising:
1. a quantity of an oxidizing agent, wherein the oxidizing agent is isolated from the surfactant; and
iii. wherein at least a portion of the first compartment and the second compartment are configured to unseal in the presence of agitation within a non-contact agitating toilet.

2. The reactive waste treatment product of claim 1, further comprising:
a. a third compartment that is sealed and disposed adjacent to the second compartment, the third compartment comprising:
i. a first liquid component.

3. The reactive waste treatment product of claim 2, wherein the first compartment, the second compartment, and the third compartment are formed by applying heat therebetween at between 90° C. to 100° C. for between 0.2 to 0.4 seconds to the package.

4. The reactive waste treatment product of claim 1, further comprising:
a. a first sealed end, wherein the first sealed end is disposed adjacent to one of the first compartment and the second compartment and formed by applying heat between 110° C. to 120° C. at greater than 0.5 seconds to the package.

5. The reactive waste treatment product of claim 1, wherein the surfactant is a foamable surfactant that is granular.

6. The reactive waste treatment product of claim 1, wherein the surfactant is a soap that is granular.

7. A reactive waste treatment product comprising:
a. a package that is fluidly disintegrable, the package comprising:
i. a first compartment containing:
1. a surfactant;
ii. a second compartment containing:
1. an oxidizing agent; and
iii. a barrier that prevents the sodium percarbonate from mixing with the surfactant.

8. The reactive waste treatment product of claim 7, wherein the second compartment is disposed within the first compartment.

9. The reactive waste treatment product of claim 7, wherein the package is made of a dissolvable paper.

10. The reactive waste treatment product of claim 7, wherein the first compartment, the second compartment, and the barrier disintegrate in the presence of a liquid.

11. The reactive waste treatment product of claim 7, wherein the package is made of a paper product embedded with a polyvinyl alcohol.

12. The reactive waste treatment product of claim 7, wherein a combination of the surfactant with the oxidizing agent, the surfactant comprises between 40% to 97.75% of the combination.

13. The reactive waste treatment product of claim 7, wherein a combination of the oxidizing agent with the surfactant, the oxidizing agent comprises between 10% to 20% of the combination.

14. The reactive waste treatment product of claim 7, wherein the package comprises material selected from a list of polyvinyl alcohol, dissolvable plastic, polyvinyl acetate, cellulose ethers, gum acacia, starch, dextrin, dissolvable paper, non-calendared paper product, kraft paper, cellophane, and a combination thereof.

15. The reactive waste treatment product of claim 7, wherein the package disintegrates in the presence of a fluid so that the surfactant and the oxidizing agent react together in contact with an organic waste material when deposited in a non-contact agitating toilet.

16. The reactive waste treatment product of claim 7, wherein the barrier disintegrates in the presence of a fluid to allow the surfactant and the oxidizing agent to mix.

17. A method of waste treatment comprising the steps of:
a. inserting a first dry component in a first compartment of a waste treatment package;
b. inserting a second dry component in a second compartment of the waste treatment package, wherein the second dry component is isolated from the first dry component;
c. depositing the waste treatment package into a toilet; and
d. agitating the first dry component and the second dry component with a waste within the toilet.

18. The method of claim 17, further comprising the step of:
a. using a fluidly disintegrable material for the waste treatment package; and
b. disintegrating the waste treatment package within the toilet in the presence of a fluid.

19. The method of claim 18, wherein the material of the waste treatment package ranges in thickness from 0.5 millimeters (mm) to 3 mm and disintegrates within approximately 30 seconds from contact with the fluid.

20. The method of claim 19, further comprising the step of:
a. connecting a plurality of waste treatment packages together, wherein a perforated seal exists between a first waste treatment package and a second waste treatment package.
